(19) United States
(12) Patent Application Publication
(10) Pub. No.: US 2024/0281820 A1
(43) Pub. Date: Aug. 22, 2024

(54) TRANSACTION PROCESSING DEVICE AUTHENTICATION

(71) Applicant: Hint, Inc., Pleasanton, CA (US)

(72) Inventors: Muthanna Nischal Ammatanda, Fremont, CA (US); Abraham Benjamin de Waal, San Jose, CA (US); Roman Tsymbalenko, Kharkiv (UA); Rostyslav Morozov, Kyiv (UA); Vijaysudh Madhusoodhan, San Ramon, CA (US); Thomas Quinto, Poway, CA (US)

(21) Appl. No.: 18/584,657

(22) Filed: Feb. 22, 2024

Related U.S. Application Data
(60) Provisional application No. 63/447,583, filed on Feb. 22, 2023.

(51) Int. Cl. G06Q 20/40

(52) U.S. Cl. CPC G06Q 20/409; G06Q 20/4014

(57) ABSTRACT

Systems and methods herein describe using an authentication system to remotely authenticate the end payment devices. The authentication system receives authentication data associated with a transaction processing computing device, generates identity data for the transaction processing computing device, transmits the identity data to the transaction processing computing device, authenticates the transaction processing computing device and transmits data to an MQTT broker server.

### CLAIM OF PRIORITY

This application claims the benefit of the priority to U.S. Provisional Patent Application Ser. No. 63/447,583 filed Feb. 22, 2023, which is incorporated by reference herein in their entirety.

### TECHNICAL FIELD

Embodiments herein generally relate to remote authentication of an end-payment device. More specifically, but not by way of limitation, embodiments herein describe transaction processing device authentication.

### BACKGROUND

Authenticating and securing transactions between an entity and clients is important to protect the proper functioning of computer devices so that the devices are not subject to fraudulent activities.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example transaction system for conducting transactions over a network.

FIG. 2 is an illustration of the transaction processing server, according to an embodiment.

FIG. 3 is an illustration of an MQTT protocol and a polling protocol in a transaction system.

FIG. 4 is an illustration of a flowchart of an example method for authenticating a transaction processing device, remotely, for use in an MQTT-protocol system

FIG. 5 is a block diagram illustrating a software architecture, which can be installed on any one or more of the devices described herein.

FIG. 6 is a diagrammatic representation of the machine within which instructions (e.g., software, a program, an application, an applet, an app, or other executable code) for causing the machine to perform any one or more of the methodologies discussed herein may be executed.

### DETAILED DESCRIPTION

Systems herein describe increasing the efficiency of card present transactions with an end payment device. Typically, when authenticating an Internet of Things (IoT) device (e.g., an end payment device), the device is physically present. The physical presence of the device allows access to device certificates and thereby the ability to embed such certificates for authentication. However, when the devices are not physically present, authenticating the device is a more complex technical problem. Securing the end payment device is essential to protect the integrity of transactions that occur at the end payment device. Solutions herein describe using an authentication system to remotely authenticate the end payment devices.

Some solutions utilize a polling mechanism in which a device is pinging a set of servers to determine whether there is any activity that it needs to respond to. Those previous efforts which utilize standard hypertext transfer protocols (HTTP) require a constant polling of the devices at a predefined frequency. These methods cause network traffic and latency issues that negatively impact the overall performing of the server system.

The described systems and methods utilize an MQ Telemetry Transport (MQTT) protocol that allows a device to have a dedicated connection to a centralized service. This solution reduces the footprint between the device (e.g., an end transaction device) and server resources. A server can initiate a payment on a payment device without the server constantly polling the device.

The MQTT protocol uses a publish/subscribe model. While in traditional network communications the client devices and server communicate directly, in an MQTT protocol, a third component, called a broker, handles communication between publishers and subscribers. The broker filters incoming messages from publishes and delivers them to the appropriate subscribers. An MQTT client is any device that communicates using MQTT over a network. An MQTT broker is a system that receives and filters messages between different clients. An MQTT topic is what the MQTT broker uses to filter messages between the MQTT clients. Topics are organized similar to a computer file or folder directory.

The proposed systems and methods authenticate an end payment device using MQTT. The end payment devices are physically located in a location that is different from where a user of the authentication system that remotely authenticates the end payment devices. The authentication system queries the devices for a merchant identification number and a serial number. The authentication system can identify the location of the device based on the aforementioned queried parameters.

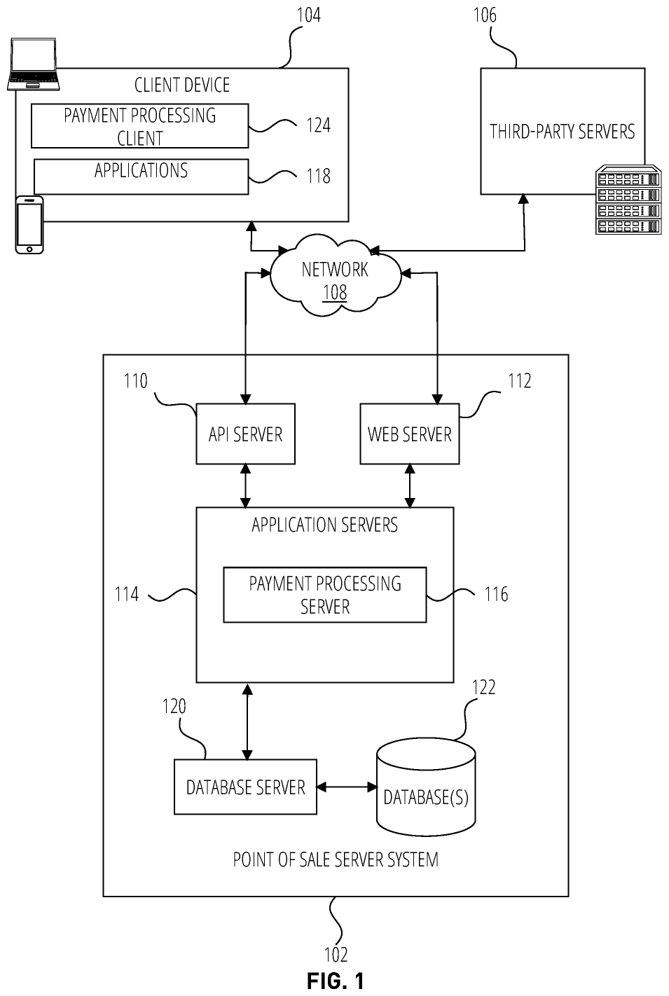

FIG. 1 is a block diagram showing an example transaction (e.g., transaction, or PoS) system for conducting transactions over a network. The transaction system includes multiple instances of a client device 104, each of which hosts a number of applications, including a payment processing client 124 and other applications 118. Each payment processing client 124 communicatively coupled to other instances of the payment processing client 124 (e.g., hosted on respective other client devices 104), a point-of-sale server system 102 and third-party servers 106 via a network 108 (e.g., the Internet). The applications 118 can also communicate with other locally hosted applications 118 using Applications Program Interfaces (APIs).

The point-of-sale server system 102 provides server-side functionality via the network 108 to a payment processing client 124. While certain functions of the transaction system are described herein as being performed by either a payment processing client 124 or by the point-of-sale server system 102, the location of certain functionality either within the payment processing client 124 or the point-of-sale server system 102 may be a design choice. For example, it may be technically preferable to initially deploy certain technology and functionality within the point-of-sale server system 102 but to later migrate this technology and functionality to the payment processing client 124 where a client device 104 has sufficient processing capacity.

The point-of-sale server system 102 supports various services and operations that are provided to the payment processing client 124. Such operations include transmitting data to, receiving data from, and processing data generated by the payment processing server 116. This data may include transaction data, customer data, product data, subscription data and provider data, as examples. Data exchanges within the point-of-sale server system 102 are invoked and controlled through functions available via user interfaces (UIs) of the payment processing client 124.

Turning now specifically to the point-of-sale server system 102, an Application Program Interface (API) server 110 is coupled to, and provides a programmatic interface to, application servers 114. The application servers 114 are communicatively coupled to a database server 120, which facilitates access to a database(s) 122 that stores data associated with the transactions processed by the application servers 114. Similarly, a web server 112 is coupled to the application servers 114 and provides web-based interfaces to the application servers 114. To this end, the web server 112 processes incoming network requests over the Hypertext Transfer Protocol (HTTP) and several other related protocols.

The API server 110 receives and transmits transaction data (e.g., commands and transaction data) between the client device 104 and the application servers 114. Specifically, the API server 110 provides a set of interfaces (e.g., routines and protocols) that can be called or queried by the payment processing client 124 in order to invoke functionality of the application servers 114. The API server 110 exposes various functions supported by the application servers 114, including account registration, subscription creations and management, the processing of transactions, authenticating devices, via the application servers 114, from a particular payment processing client 124 to another payment processing client 124.

The application servers 114 host a number of server applications and subsystems, including for example a payment processing client 124. The payment processing server 116 provides functionalities for authenticating transaction processing devices (e.g., client device 104). In some examples, the payment processing server 116 communicates with the client device 104 using an MQ Telemetry Transport (MQTT) protocol. The MQTT protocol allows for a persistent connection (unlike during polling) between the payment processing server 116 and the payment processing client 124. The MQTT protocol is a publisher-subscriber model. In traditional systems, a client and server communicate directly. However, in an MQTT model, a broker handles communications between a message sender (publisher) and a message receiver (subscriber). Further details regarding the payment processing server 116 are provided below.

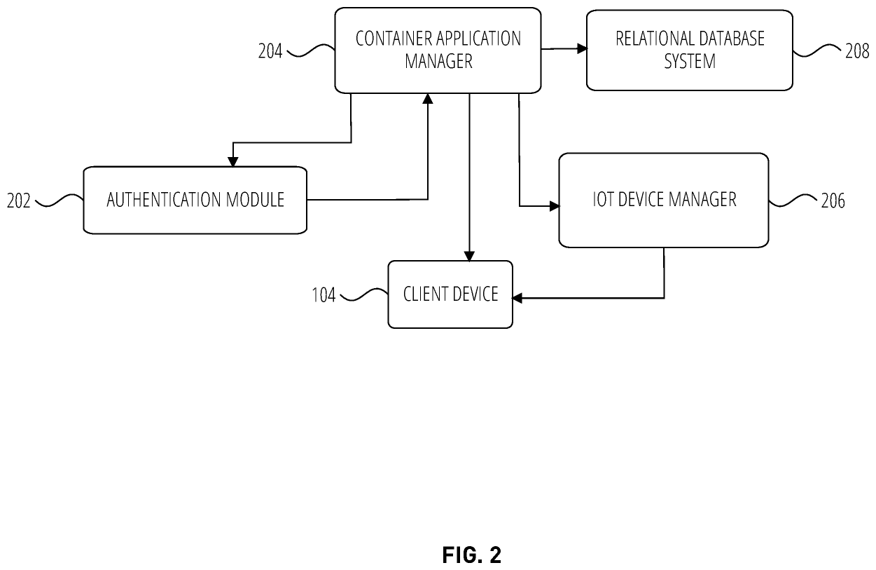

FIG. 2 is an illustration of the payment processing server 116. The payment processing server 116 is shown to include multiple components: the authentication module 202, the container application manager 204, the Internet of Things (IoT) device manager 206, the database module 208, and a client device 104. The authentication module 202 stores a list of all authenticated users (e.g., authenticated client devices) in the system. The authentication module 202 further delivers temporary, limited-privilege credentials that are used to get access to the MQTT broker (e.g., payment processing server 116). In some examples the authentication module 202 is implemented using an access management platform that implements user authentication and access management.

The container application manager 204 creates communication policy to control access to the corresponding MQTT topics. Furthermore, the container application manager 204 works as a proxy between the client device 104, the MQTT broker (payment processing server 116) and other services in the system.

The identity module (not pictured) allows a device to connect to the MQTT broker, publish to the MQTT topics, subscribe to MQTT topics and receive messages from the MQTT topics. The identity module allows the system to create a user in the authentication user pool. The database module 208 includes various databases (e.g., database(s) 122) for use in the point-of-sale server system 102. The database module 208 can be implemented a relational database system. The Internet of Things (IoT) device manager 206 allows the client device 104 to connect to the MQTT broker and is used by the client device 104 to receive messages from the server. The IoT device manager 206 can be implemented using a managed cloud service.

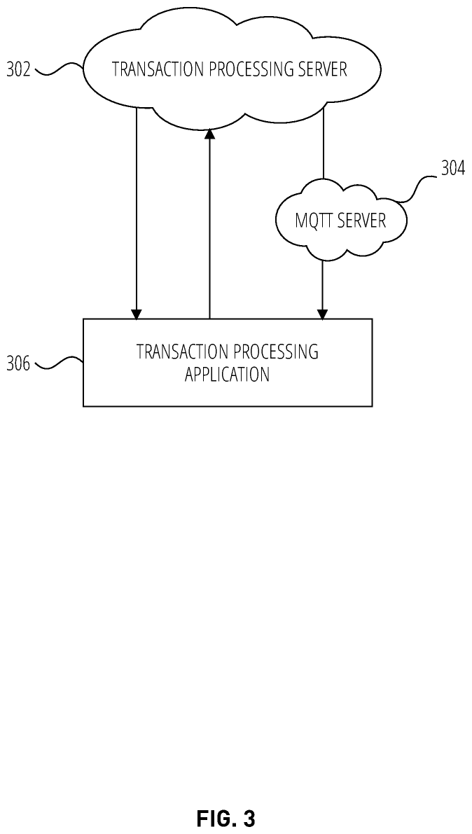

FIG. 3 is an illustration of an MQTT protocol and polling protocol in a transaction system. The transaction processing server 302 represents internal systems used to conduct transactions and transaction processing. The transaction processing application 306 is an application that runs on the client device 104 (e.g., the transaction processing end device). The transaction processing server 302 is an illustration of the payment processing server 116. The transaction processing server 302 has a super-identity, which provides wildcard access to all device MQTT “topics” as well as for system MQTT “topics” for device management. The “topics” are illustrated in connection with the IoT device manager 206. The transaction processing computing device (e.g., client device 104) receives an identity with limited access which bounds specifically to its HSN (hardware serial number) and MID (Merchant ID) combination, with no access to system topics.

In some examples, the outgoing requests for communicating with the payment processing server 116 are communicated using an HTTPS protocol and incoming requests to the client device 104 are received using an MQTT protocol. In some examples, the incoming requests may be received using a combination of MQTT and polling protocols. The MQTT server 304 is an MQTT broker (e.g., a server).

When devices are being configured, an operator can enter the MID and HSN. The payments processing server 114 generates a one-time use random eight-digit code (also referred to herein as an access code). That code must be entered on the transaction processing application 306 before the device can be used to accept payments.

When the device is registered after entering the one-time code, a long living token is generated. The token along with the MID and HSM used to retrieve the identity details from the authentication module 202. The authentication details are used to connect to IoT device manager 206. The identity details include a client identification which uniquely identifies an MQTT connection. Two client devices with the same client identification cannot be connected concurrently to a same endpoint. The identity details further include an access key, a secret key, a session token, and an expiration epoch time for the session token. The aforementioned four parameters are used to establish the MQTT connection from the client device to the IoT device manager 206 along with a URL for a server coupled to the IoT device manager 206.

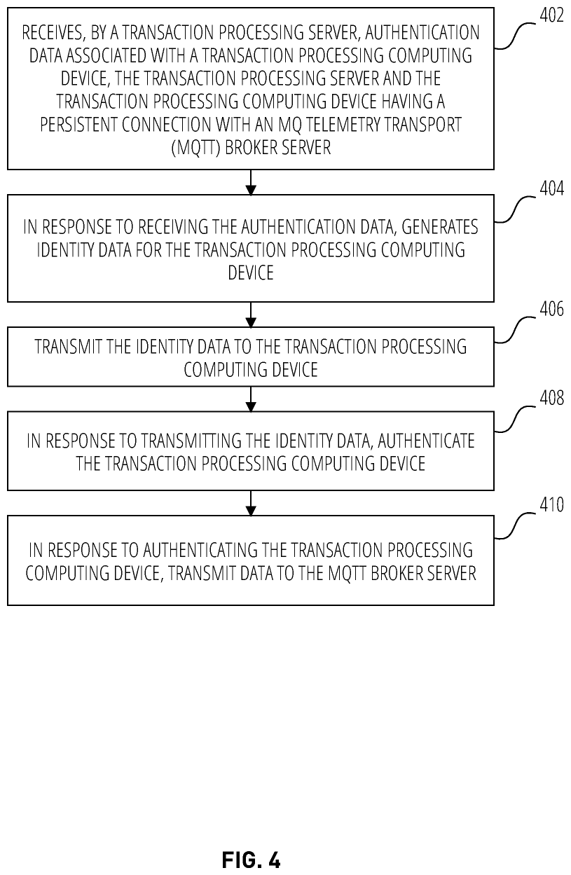

FIG. 4 is an example method for authenticating a transaction processing device, remotely, for use in an MQTT-protocol system. In operation 402, the payment processing server 116 receives authentication data associated with a transaction processing computing device. The transaction processing device is in a remote location physically distant from the payment processing server 116.

For example, the client device 104 sends the HSN (hardware serial number), MID (merchant ID) and access code to the payment processing server 116. The payment processing server 116 and the transaction processing computing device (client device 104) have a persistent connection with an MQTT broker server. Using an MQTT topic, the payment processing server 116 can send actions to a specific device via the IoT device manager 206. The information of the MID and the HSN are provided to the payment processing server 116 via payloads being sent to the payment processing server 116. The MQTT topic includes the MID and HSN as part of it which helps in directing the request to the intended device.

In operation 404, the payment processing server 116 generates identity data for the transaction processing computing device in response to receiving the authentication data. The identity data is generated by the authentication module 202. The identity data is an access code, key pair data, session token and expiration date.

In operation 406, the payment processing server 116 transmits the identity data to the transaction processing computing device. In operation 408, the payment processing server 116 in response to transmitting the identity data, authenticates the transaction processing computing device. In operation 410, in response to authenticating the transaction processing computing device, the payment processing server 116 transmits data to the MQTT broker server. The transaction processing computing device receives information from the MQTT broker server based on the persistent connection it has to the MQTT broker server. In some examples, the client ID and key pairs are stored in a database(s) 122. Both of the transaction processing computing device (e.g., client device 104) and the payment processing server 116 have a persistent connection the MQTT broker server (e.g., MQTT server 304). However, while the payment processing server 116 can publish to any MQTT “topic,” the transaction processing computing device can only receive information pertaining to a single MQTT “topic.”

### Software Architecture

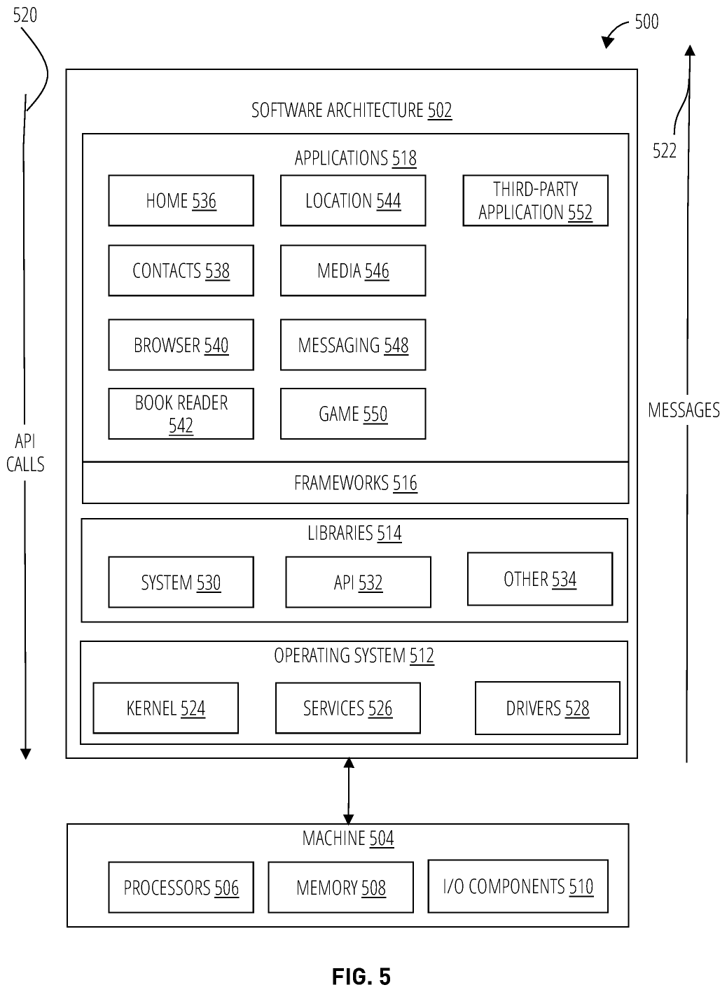

FIG. 5 is a block diagram 500 illustrating a software architecture 502, which can be installed on any one or more of the devices described herein. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematic functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein

### Machine Architecture

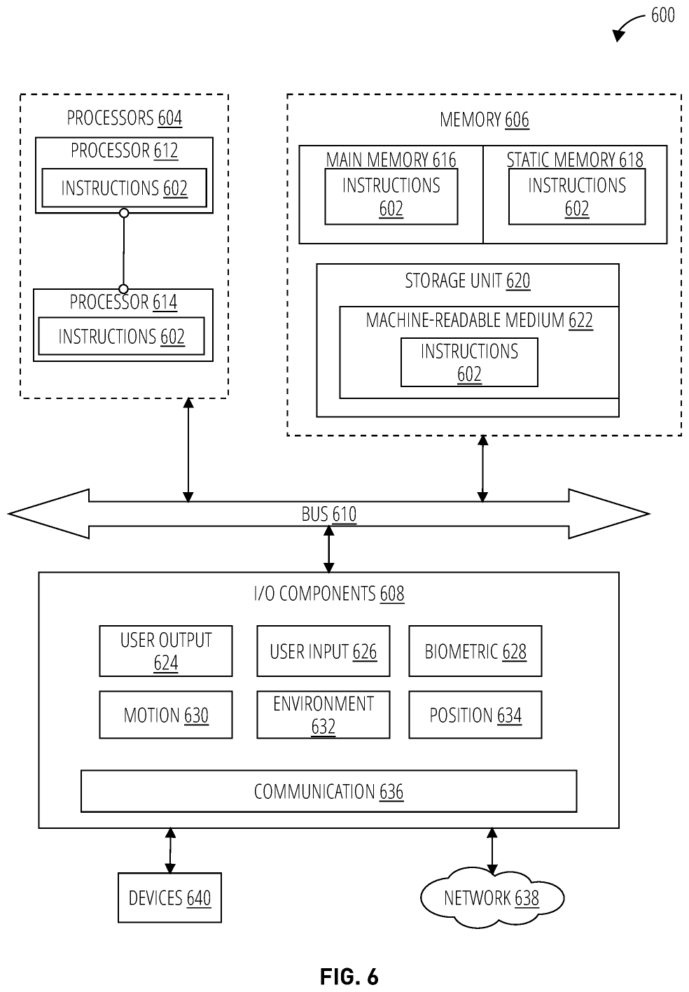

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. The machine 600, for example, may comprise the point-of-sale server system 102. In some examples, the machine 600 may also comprise both client and server systems, with certain operations of a particular method or algorithm being performed on the server-side and with certain operations of the particular method or algorithm being performed on the client-side.

The machine 600 may include processors 604, memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include biometric components 628, motion components 630, environmental components 632, or position components 634, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving, by a transaction processing server, authentication data associated with a transaction processing computing device, the transaction processing server and the transaction processing computing device having a persistent connection with an MQ Telemetry Transport (MQTT) broker server;
in response to receiving the authentication data, generating identity data for the transaction processing computing device;
transmitting the identity data to the transaction processing computing device;
in response to transmitting the identity data, authenticating the transaction processing computing device; and
in response to authenticating the transaction processing computing device, transmitting data to the MQTT broker server.

2. The method of claim 1, wherein the authentication data comprises a hardware serial number, and a merchant identification.

3. The method of claim 1, wherein the identity data comprises an access code, a key pair, a session token and an expiration date.

4. The method of claim 3, wherein the access code is a random one-time use code.

5. The method of claim 1, wherein the transaction processing computing device is physically located in a remote location physically distant from the transaction processing server.

6. The method of claim 1, wherein the identity data is received using MQTT.

7. The method of claim 1, wherein the data transmitted to the MQTT broker server is associated with a transaction on the transaction processing computing device.

8. A system comprising:
a processor; and
a memory storing instructions that, when executed by the processor, configure the system to perform operations comprising:
receiving, by a transaction processing server, authentication data associated with a transaction processing computing device, the transaction processing server and the transaction processing computing device having a persistent connection with an MQ Telemetry Transport (MQTT) broker server;
in response to receiving the authentication data, generating identity data for the transaction processing computing device;
transmitting the identity data to the transaction processing computing device;
in response to transmitting the identity data, authenticating the transaction processing computing device; and
in response to authenticating the transaction processing computing device, transmitting data to the MQTT broker server.

9. The system of claim 8, wherein the authentication data comprises a hardware serial number, and a merchant identification.

10. The system of claim 8, wherein the identity data comprises an access code, a key pair, a session token and an expiration date.

11. The system of claim 10, wherein the access code is a random one-time use code.

12. The system of claim 8, wherein the transaction processing computing device is physically located in a remote location physically distant from the transaction processing server.

13. The system of claim 8, wherein the identity data is received by the transaction processing device from the transaction processing server using MQTT.

14. The system of claim 8, wherein the data transmitted to the MQTT broker server is associated with a transaction on the transaction processing computing device.

15. A non-transitory computer-readable storage medium, the computer-readable storage medium including instructions that when executed by a computer, cause the computer to perform operations comprising:
receiving, by a transaction processing server, authentication data associated with a transaction processing computing device, the transaction processing server and the transaction processing computing device having a persistent connection with an MQ Telemetry Transport (MQTT) broker server;
in response to receiving the authentication data, generating identity data for the transaction processing computing device;
transmitting the identity data to the transaction processing computing device;
in response to transmitting the identity data, authenticating the transaction processing computing device; and
in response to authenticating the transaction processing computing device, transmitting data to the MQTT broker server.

16. The non-transitory computer-readable storage medium of claim 15, wherein the authentication data comprises a hardware serial number, and a merchant identification.

17. The non-transitory computer-readable storage medium of claim 15, wherein the identity data comprises an access code, a key pair, a session token and an expiration date.

18. The non-transitory computer-readable storage medium of claim 17, wherein the access code is a random one-time use code.

19. The non-transitory computer-readable storage medium of claim 15, wherein the transaction processing computing device is physically located in a remote location physically distant from the transaction processing server.

20. The non-transitory computer-readable storage medium of claim 15, wherein the identity data is received by the transaction processing device from the transaction processing server using MQTT.
